(19) United States
(12) Patent Application Publication
(10) Pub. No.: US 2021/0334519 A1
(43) Pub. Date: Oct. 28, 2021

(54) INFORMATION PROCESSING APPARATUS, METHOD, AND NON-TRANSITORY STORAGE MEDIUM

(71) Applicant: NEC Corporation, Minato-ku, Tokyo (JP)

(72) Inventor: Kapik LEE, Tokyo (JP)

(73) Assignee: NEC Corporation, Minato-ku, Tokyo (JP)

(21) Appl. No.: 17/271,252

(22) PCT Filed: Aug. 31, 2018
(86) PCT No.: PCT/JP2018/032431

§ 371 Date: Feb. 25, 2021

(51) Int. Cl. G06K 9/00; G06K 9/62

(52) U.S. Cl. CPC G06K 9/00288; G06K 9/6256; G06K 9/00228

(57) ABSTRACT

The information processing apparatus (2000) acquires a first profile face image (10) and a first frontal face image, and generates a frontal face image (20) based on the first profile face image (10), with a face image generator (30). The face image generator (30) has been trained so as to generate the frontal face image (20) based on the first profile face image (10). The information processing apparatus (2000) performs face recognition on the generated second frontal face image (20) with comparing to the first frontal face image. As a result, it is computed a first recognition score, which indicates probability of that the generated second frontal face image (20) and the acquired first frontal face image (15) are of the same subject. The information processing apparatus (2000) performs training on the face image generator (30) using the first recognition score that is a feedback from the face recognition.

### TECHNICAL FIELD

Embodiments of the invention generally relate to the field of image generation.

### BACKGROUND ART

An image generation system called Generative and Adversarial Networks (abbreviated as GAN) is developed. GAN is used for, for example, generation of a face image from another face image at a different pose. An example of a conventional system of GAN is described in Non-Patent Literature 1. This conventional system of GAN includes input of noise (device for random noise input), generator (an image generating device which generates images from the input noise), output of generated image and discriminator (a device which determines whether the image is a real image or a fake image generated by the generator).

The conventional system of GAN having such a structure operates as follows. The generator is trained to generate an image from a noise input. The generated image tries to fool the discriminator that the generated image is a real image instead of a generated fake image. At the same time, the discriminator is trained to distinguish generated fake images from real images.

Another example of a conventional system of GAN is described in Non-Patent Literature 2. This conventional system of GAN includes an input image instead of input noise, generator, output of generated image and discriminator.

This conventional system of GAN operates as follows. The generator is trained to generate an image from an input image. The generated fake image will try to fool the discriminator that the generated fake image and the input image is a real pair of images. At the same time, the discriminator is trained to distinguish real pair of images and generated pair of images.

As to a patent literature, PL1 discloses to perform affine transformation on a face image in which the subject does not face the front, thereby obtaining another face image in which the subject faces the front.

### RELATED DOCUMENTS

### Patent Document

[PATENT DOCUMENT 1] Japanese Patent Application Publication No. 2011-138388

### Non-Patent Documents

[NON-PATENT DOCUMENT 1] I. J. Goodfellow, J. Pouget-Abadie, M. Mirza, B. Xu, D. Warde-Farley, S. Ozair, A. Courville, and Y. Bengio, “Generative Adversarial Nets”, Curran Associates, Inc., Advances in Neural Information Processing Systems 27, pp. 2672-2680, Jun. 10, 2014.

[NON-PATENT DOCUMENT 2] P. Isola, J. Zhu, T. Zhou and A. A. Eros, “Image-to-Image Translation with Conditional Adversarial Networks”, ArXiv e-prints, Nov. 22, 2017.

### SUMMARY OF INVENTION

### Technical Problem

The problem of the above conventional methods disclosed by NPL1 and NPL2 is that the discriminator can only determine the probability of an input image being a real image. In the case of a generated face image, the discriminator can only give the probability of the generated face image being a real face image but cannot determine how much personal detail the generated face image contains and whether the generated face image is of the same identity as the input face image. Therefore, with conventional methods' discriminator, the generator usually generates face images that tend to be a mean face that lacks personal details and identity. As to PL1, it does not mention about such a discriminator.

An objective of the present invention is to provide a way of training a face image generator capable of generating face images including identity details of the subject.

### Solution to Problem

There is provided an information processing apparatus comprising: 1) a first acquisition unit acquiring a first profile image and a first frontal face image, the first profile face image including a profile face of a subject, the first frontal face image including a frontal face of a same subject as the first profile face image; 2) a generation unit generating a second frontal face image of the subject based on the acquired first profile face image using a face image generator, the face image generator is trained so as to generate the second frontal face image based on the first profile face image so that the second frontal face image contains personal details of the subject; 3) a face recognition unit performing face recognition on the generated second frontal face image with comparing to the first frontal face image, and thereby computing a first recognition score that indicates probability of that the second frontal face image and the first frontal face image are of the same subject; and 4) a training unit performing training on the face image generator using the first recognition score.

There is provided a control method performed by a computer. The control method comprises: 1) acquiring a first profile image and a first frontal face image, the first profile face image including a profile face of a subject, the first frontal face image including a frontal face of a same subject as the first profile face image; 2) generating a second frontal face image of the subject based on the acquired first profile face image using a face image generator, the face image generator is trained so as to generate the second frontal face image based on the first profile face image so that the second frontal face image contains personal details of the subject; 3) performing face recognition on the generated second frontal face image with comparing to the first frontal face image, and thereby computing a first recognition score that indicates probability of that the second frontal face image and the first frontal face image are of the same subject; and 4) performing training on the face image generator using the first recognition score.

### Advantageous Effects of Invention

In accordance with the present invention, it is provided a way of training a face image generator capable of generating face images including identity details of the subject.

### BRIEF DESCRIPTION OF DRAWINGS

Aforementioned objects, procedure and technique for behavior modeling will be made comprehensible via selected example embodiments, described below, and the aided drawings.

FIG. 1 illustrates an overview of operations of an information processing apparatus according to Example Embodiment 1.

FIG. 2 is a block diagram illustrating a function-based configuration of the information processing apparatus of Example Embodiment 1.

FIG. 3 is a block diagram illustrating an example of hardware configuration of a computer realizing the information processing apparatus of Example Embodiment 1.

FIG. 4 is a flowchart that illustrates the process sequence performed by the information processing apparatus of Example Embodiment 1.

FIG. 5 illustrates an overview of operations of an information processing apparatus according to Example Embodiment 2.

FIG. 6 is a block diagram illustrating a function-based configuration of the information processing apparatus of Example Embodiment 2.

FIG. 7 is a flowchart that illustrates the process sequence performed by the information processing apparatus of Example Embodiment 2

### DESCRIPTION OF EMBODIMENTS

Hereinafter, example embodiments of the present invention will be described with reference to the accompanying drawings. In all the drawings, like elements are referenced by like reference numerals and the descriptions thereof will not be repeated.

### Example Embodiment 1

### Overview

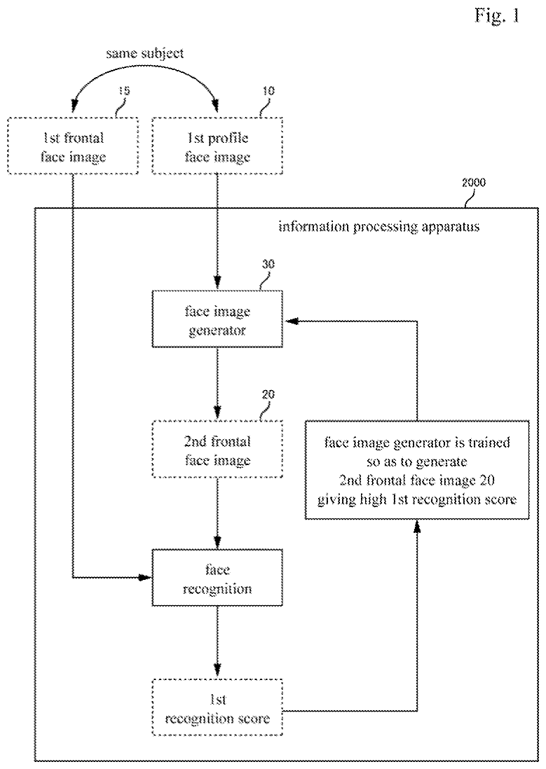

FIG. 1 illustrates an overview of operations of an information processing apparatus 2000 according to Example Embodiment 1. The information processing apparatus 2000 of Example Embodiment 1 includes a face image generator that is trained based on a feedback from face recognition on the previously generated face image. An overview of the operations of the information processing apparatus 2000 is as follows.

First, the information processing apparatus 2000 acquires a first profile face image 10 and a first frontal face image 15 which has the same identity as the first profile face image 10. The first profile face image 10 may be any type of image including the face of a subject. For example, the first profile face image 10 includes the face of the subject with a head pose at horizontal 90 degree or at other angles. The first frontal face image 15 includes a frontal face of the subject. Note that, subject may be not only person but also other animal like dog, cat, and so on.

Second, the information processing apparatus 2000 generates a second frontal face image 20 based on the acquired first profile face image 10, with a face image generator 30. The face image generator 30 has been trained so as to generate the second frontal face image 20 based on the first profile face image 10. The second frontal face image 20 is generated so as to include a frontal face of the same subject as that of the first profile face image 10. Specifically, the face image generator 30 is trained so as to generate the second frontal face image 20 so that the second frontal face image 20 contains personal details of the subject of the first profile face image 10. However, the second frontal face image 20 is different from the first profile face image 10. For example, the second frontal face image 20 is different in the pose of the face from the first profile face image 10.

Third, the information processing apparatus 2000 performs face recognition on the generated second frontal face image 20 with comparing to the first frontal face image 15, which has the same identity as the first profile face image 10. As a result, it is computed the probability of that the generated second frontal face image 20 and the acquired frontal face image are of the same subject. Hereinafter, this computed probability is called first recognition score.

Lastly, the information processing apparatus 2000 performs training on the face image generator 30 using the first recognition score that is a feedback from the face recognition. Since the subject of the second frontal face image 20 and that of the first frontal face image 15 is the same as each other, the face image generator 30 is trained so as to generate the second frontal face image 20 giving high first recognition score.

### Advantageous Effect

In accordance with the information processing apparatus 2000 of Example Embodiment 1, it can be ensured that the generated second frontal face image 20 contains personal details and has the same identity as the acquired first profile face image 10. The reason for the effect is that the face image generator 30 is trained using the result of face recognition on the generated second frontal face image 20 with comparing to the first frontal face image 15, which has the same identity as the first profile face image 10. Through face recognition, it is able to determine the identity of the generated second frontal face image 20, and hence compute the probability that the generated second frontal face image 20 has the same identity as the acquired first profile face image 10.

### Example of Function-Based Configuration

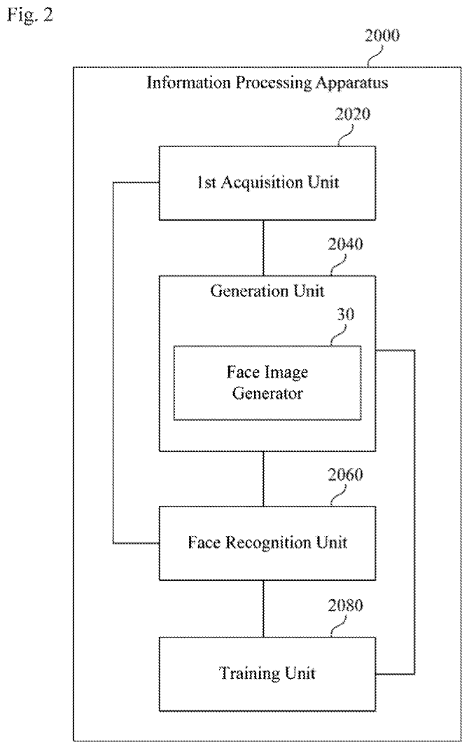

FIG. 2 is a block diagram illustrating a function-based configuration of the information processing apparatus 2000 of Example Embodiment 1. The information processing apparatus 2000 includes a first acquisition unit 2020, a generation unit 2040, a face recognition unit 2060, and a training unit 2080. The first acquisition unit 2020 acquires the first profile face image 10 and the first frontal face image 15. The generation unit 2040 generates the second frontal face image 20 based on the acquired first profile face image 10 using face image generator 30. The face image generator 30 is trained so as to generate the second frontal face image 20 based on the first profile face image 10 so that the second frontal face image 20 contains personal details of the subject of the first profile face image 10. The face recognition unit 2060 performs face recognition on the generated second frontal face image 20 and thereby computing first recognition score, which is the probability of that the generated second frontal face image 20 and the acquired first profile face image 15 are of the same subject. The training unit 2080 performs training on the face image generator 30 using the first recognition score.

### Example of Hardware Configuration

Each functional unit included in the information processing apparatus 2000 may be implemented with at least one hardware component, and each hardware component may realize one or more of the functional units. In some embodiments, each functional unit may be implemented with at least one software component. In some embodiments, each functional unit may be implemented with a combination of hardware components and software components.

The information processing apparatus 2000 may be implemented with a special purpose computer manufactured for implementing the information processing apparatus 2000, or may be implemented with a commodity computer like a personal computer (PC), a server machine, or a mobile device.

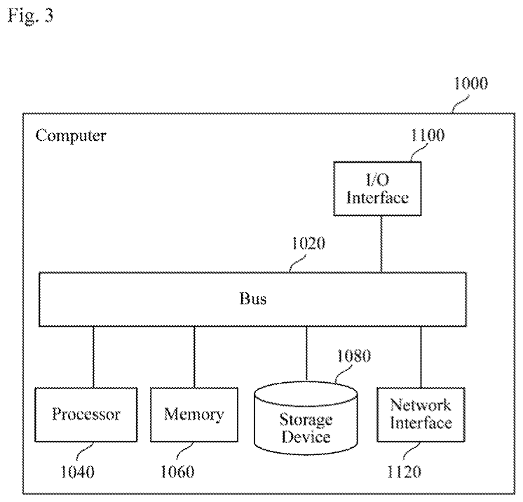

FIG. 3 is a block diagram illustrating an example of hardware configuration of a computer 1000 realizing the information processing apparatus 2000 of Example Embodiment 1. In FIG. 3, the computer 1000 includes a bus 1020, a processor 1040, a memory 1060, a storage device 1080, an input-output (I/O) interface 1100, and a network interface 1120.

The bus 1020 is a data transmission channel in order for the processor 1040, the memory 1060 and the storage device 1080 to mutually transmit and receive data. The processor 1040 is a processor such as CPU (Central Processing Unit), GPU (Graphics Processing Unit), or FPGA (Field-Programmable Gate Array). The memory 1060 is a primary storage device such as RAM (Random Access Memory). The storage medium 1080 is a secondary storage device such as hard disk drive, SSD (Solid State Drive), or ROM (Read Only Memory).

The I/O interface is an interface between the computer 1000 and peripheral devices, such as keyboard, mouse, or display device. The network interface is an interface between the computer 1000 and a communication line through which the computer 1000 communicates with another computer.

The storage device 1080 may store program modules, each of which is an implementation of a functional unit of the information processing apparatus 2000 (See FIG. 2). The CPU 1040 executes each program module, and thereby realizing each functional unit of the information processing apparatus 2000.

### Flow of Process

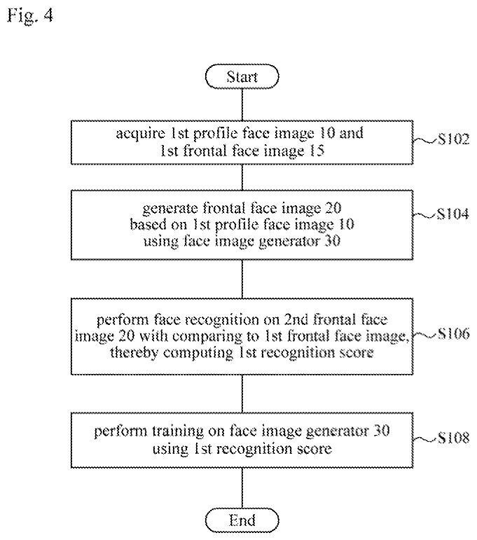

FIG. 4 is a flowchart that illustrates the process sequence performed by the information processing apparatus 2000 of Example Embodiment 1. The first acquisition unit 2020 acquires the first profile face image 10 and the first frontal face image 15 (S102). The generation unit 2040 generates the second frontal face image 20 based on the acquired first profile face image 10 using face image generator 30 (S104). The face recognition unit 2060 performs face recognition on the generated second frontal face image 20 with comparing to the first frontal face image 15, and thereby computing first recognition score (S106). The training unit 2080 performs training on the face image generator 30 using the first recognition score (S108).

### Acquisition of First Profile Face Image: S102

The first acquisition unit 2020 acquires the first profile face image 10 (S102). There may be various ways of acquiring the first profile face image 10 and the first frontal face image 15. For example, the first acquisition unit 2020 may acquire the first profile face image 10 and the first frontal face image 15 from a storage device that storing the first profile face image 10 and the first frontal face image 15. This storage device may be installed inside the information processing apparatus or outside it. In another example, the first acquisition unit 2020 may receive the first profile face image 10 and the first frontal face image 15 sent from another computer.

### Generation of Frontal Face Image: S104

The generation unit 2040 generates the second frontal face image 20 based on the acquired first profile face image 10 using face image generator 30 (S104). Specifically, the generation unit 2040 inputs the acquired first profile face image 10 into the face image generator 30, and obtains the second frontal face image 20 output from the face image generator 30.

The face image generator 30 generates the second frontal face image 20 based on the first profile face image 10 that is input thereto. The face image generator 30 is based on a model with updatable parameters.

### Face Recognition: S106

The face recognition unit 2060 performs face recognition on the second frontal face image 20 with comparing to the first frontal face image 15, thereby computing first recognition score (S106). There may be various ways to perform such face recognition. For example, the face recognition unit 2060 extracts features from both of the first frontal face image 15 and the second frontal face image 20, and compares them with each other. In this case, for example, the face recognition unit 2060 computes the first recognition score as the degree of coincidence between the features extracted from the first frontal face image 15 and those from the second frontal face image 20.

In another case, the face recognition unit 2060 can be implemented as discriminator through machine learning technique. Specifically, this discriminator feeds the first frontal face image 15 and the second frontal face image 20, and is trained so as to output the first recognition score based on the first frontal face image 15 and the second frontal face image 20 fed into it. This discriminator may be implemented as various types of models like neural network, support vector machine, and so on. Training of the face recognition unit 2060 with the first recognition score may be realized by, for example, defining a loss function used for the training based on the first recognition score.

In addition to the face recognition unit 2060, the information processing apparatus may further comprise another type of discriminator that is trained to compute a reality score, which indicates how an input image is real. Hereinafter, this discriminator is described as “second discriminator”. Specifically, the second discriminator feeds the first frontal face image 15 and the second frontal face image 20, and outputs a reality score that indicates how the second frontal face image 20 is real with respect to the first frontal face image 15. Note that, various well-known techniques can be used for implementing and training a discriminator that computes reality score.

When the information processing apparatus 2000 includes the second discriminator, the training of the face recognition unit 2060 may be performed using not only the first recognition score but also the reality score. In this case, for example, a loss function used for training the recognition unit 2060 is defined based on the reality score in addition to the recognition score.

### Training of Face Image Generator: S108

The training unit 2080 performs training on the face image generator 30 using the first recognition score (S108). Specifically, the training unit 2080 trains the face image generator 30 by updating its parameters based on the first recognition score. The parameters are updated so that the face image generator 30 with the updated parameters generates the second frontal face image 20 that gives a higher first recognition score than that given by the second frontal face image 20 generated by the face image generator with the previous parameters.

### Output of Result

The information processing apparatus may output the result of face recognition performed by the face recognition unit 2060. There may be various ways to show the result of face recognition. For example, the information processing apparatus 2000 outputs the first recognition score in any format, like text, image, or sound (voice).

In another example, the information processing apparatus shows whether or not the generated second frontal face image 20 is of the same subject as the first frontal face image 15 (and the first profile face image 10), as the result of face recognition. Specifically, the information processing apparatus 2000 may determine that the generated second frontal face image 20 is of the same subject as the first frontal face image 15 (and the first profile face image 10) when the first recognition score is greater than or equal to a predetermined threshold. On the other hand, the information processing apparatus 2000 may determine that the generated second frontal face image 20 is not of the same subject as the first frontal face image 15 (and the first profile face image 10) when the first recognition score is less than the predetermined threshold.

### Second Example Embodiment

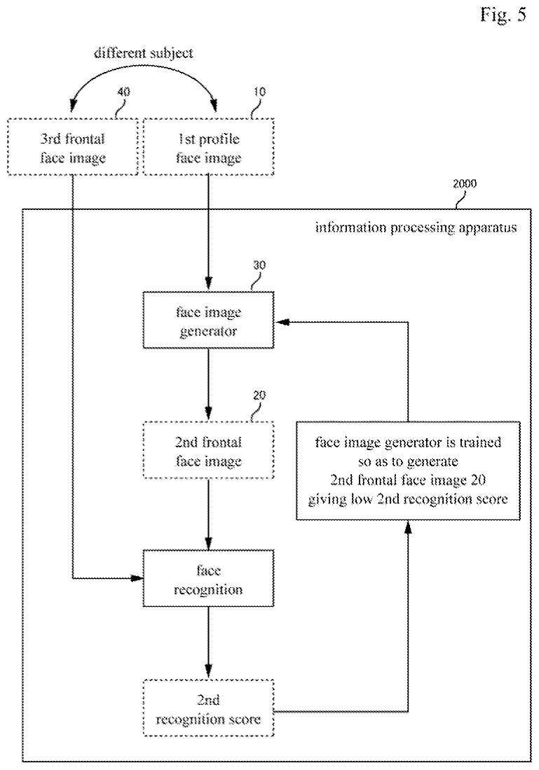

FIG. 5 illustrates an overview of operations of an information processing apparatus 2000 according to Example Embodiment 2. Except for functions explained below, the information processing apparatus 2000 of Example Embodiment 2 has the same functions as those of the information processing apparatus 2000 of Example Embodiment 1. For brevity, FIG. 5 does not depict blocks describing data or process that relates only to training based on the 1st recognition score.

The information processing apparatus 2000 of Example Embodiment 2 further acquires the third frontal face image 40, the subject of which is other than that of the first profile face image 10 and the first frontal face image 15. The information processing apparatus 2000 of Example Embodiment 2 performs face recognition on the generated second frontal face image 20 with comparing to the third frontal face image 40, and thereby computing the probability that the second frontal face image 20 and the third frontal face image 40 (and the first profile face image 10) are of the same subject. Hereinafter, this computed probability is called second recognition score.

In addition to the training using the first recognition score, the information processing apparatus 2000 of Example Embodiment 2 trains the face image generator 30 using the second recognition score. Since the subject of the second frontal face image 20 and that of the third frontal face image 40 is different from each other, the second recognition score should be low value. Thus, the face image generator 30 is trained so as to generate the second frontal face image 20 having low second recognition score. At least, the second recognition score should be lower than the first recognition score.

Note that, the information processing apparatus 2000 may acquire a plurality of the third frontal face images. In this case, the second recognition score is computed for each of the plurality of the third frontal face images, and the plurality of the second recognition scores are used for training the face recognition unit 2060.

### Advantageous Effect

In accordance with the information processing apparatus 2000 of Example Embodiment 2, it can be ensured that the generated second frontal face image 20 has different identity from the third frontal face image 40 the subject of which is different from that of the first frontal face image 15 (and the first profile face image 10). The reason for the effect is that the face image generator 30 is trained using the result of face recognition on the generated second frontal face image 20 using the third frontal face image 40, the subject of which is different from that of the second frontal face image 20. Through face recognition, it is able to determine the identity of the second frontal face image 20, and hence precisely compute the probability that the second frontal face image 20 has a different identity as the acquired third frontal face image 40.

Hereinafter, more details of the information processing apparatus 2000 of Example Embodiment 2 will be described.

### Example of Function-Based Configuration

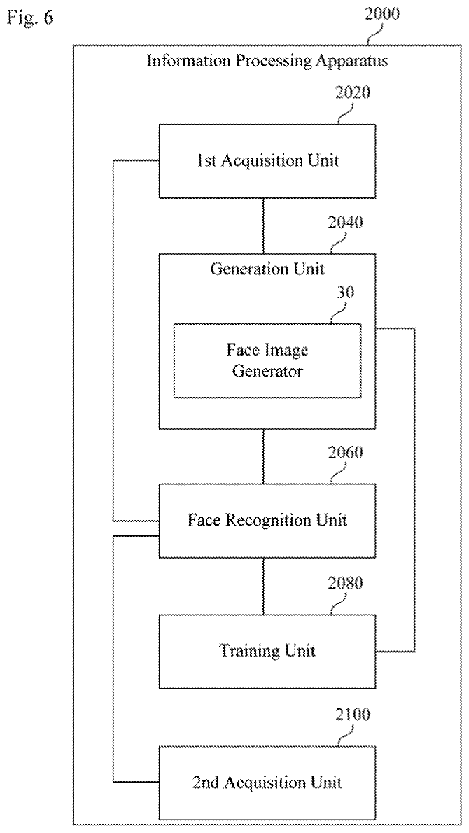

FIG. 6 is a block diagram illustrating a function-based configuration of the information processing apparatus of Example Embodiment 2. In addition to the function blocks depicted in FIG. 2, the information processing apparatus 2000 of Example Embodiment 2 further includes a second acquisition unit 2100. The second acquisition unit 2100 acquires the third frontal face image 40, the subject of which is other than that of the first profile face image 10 and the first frontal face image 15. The face recognition unit 2060 of Example Embodiment 2 performs face recognition on the generated second frontal face image 20 with comparing to the third frontal face image 40, and thereby computing the second recognition score. The training unit 2080 of Example Embodiment 2 trains the face image generator 30 using the second recognition score.

### Example of Hardware Configuration

The information processing apparatus 2000 of Example Embodiment 2 may be implemented as the computer 1000 in the same manner as the information processing apparatus 2000 of Example Embodiment 1. However, the storage device 1080 of Example Embodiment 2 further includes program modules that implement the functions of the information processing apparatus 2000 of Example Embodiment 2.

### Flow of Processes

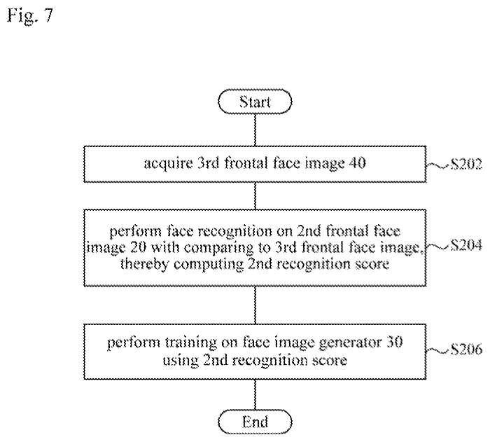

FIG. 7 is a flowchart that illustrates the process sequence performed by the information processing apparatus 2000 of Example Embodiment 2. The second acquisition unit 2100 acquires the third frontal face image 40 (S202). The face recognition unit 2060 performs face recognition on the generated second frontal face image 20 with comparing to the third frontal face image 40, and thereby computing the second recognition score (S204). The training unit 2080 performs training on the face image generator 30 using the second recognition score (S206).

Note that, the processes illustrated in FIG. 7 may be performed after or in parallel with those illustrated in FIG. 4. However, at least, S204 is performed after Step 104 since S204 requires the second frontal face image 20 that is generated in S104.

### Acquisition of Second Profile Face Image: S202

The second acquisition unit 2100 acquires the third frontal face image 40 (S202). The third frontal face image 40 can be acquired in a similar manner to the first profile face image 10 and the first frontal face image 15.

### Face Recognition Using Second Profile Face Image: S204

The face recognition unit 2060 performs face recognition on the generated second frontal face image 20 with comparing to the third frontal face image 40, and thereby computing the second recognition score (S204). The second recognition score can be computed in a similar manner to the first recognition score, except that it is not the first frontal face image 15 but the third frontal face image 40 to be compared with the second frontal face image 20.

### Training of Face Image Generator Using Second Recognition Score: S206

The training unit 2080 performs training on the face image generator 30 using the second recognition score (S206). As mentioned above, the face image generator 30 is based on a model with updatable parameters. The training unit 2080 trains the face image generator 30 by updating its parameters to make the second recognition score as low as possible, because it is a recognition score of face images the subject of which are different with each other.

### Output of Result

The information processing apparatus 2000 may output the result of face recognition on the second frontal face image 20 with comparing to the third frontal face image 40, in a similar manner to the result of face recognition with comparing to the first frontal face image 15.

As described above, although the example embodiments of the present invention have been set forth with reference to the accompanying drawings, these example embodiments are merely illustrative of the present invention, and a combination of the above example embodiments and various configurations other than those in the above-mentioned example embodiments can also be adopted.

What is claimed is:

1. An information processing apparatus comprising:
at least one memory configured to store one or more instructions; and
at least one processor configured to execute the one or more instructions to:
acquire a first profile face image and a first frontal face image, the first profile face image including a profile face of a subject, the first frontal face image including a frontal face of a same subject of the first profile face image;
generate a second frontal face image of the subject based on the acquired first profile face image using a face image generator, the face image generator is trained so as to generate the second frontal face image based on the first profile face image so that the frontal face image contains personal details of the subject;
perform face recognition on the second frontal face image with comparing to the first frontal face image, and thereby compute a first recognition score that indicates probability of that the second frontal face image and the first frontal face image are of the same subject; and
perform training on the face image generator using the first recognition score.

2. The information processing apparatus of claim 1:
wherein the processor is further configured to execute the one or more instructions to:
acquire a third frontal face image that includes a face of a subject, the subject of the third frontal face image being different from the subject of the first profile face image and the first frontal face image;
perform face recognition on the second frontal face image with comparing to the third frontal face image, and thereby compute a second recognition score that indicates probability of that the second frontal face image and third frontal face image are of the same subject; and
perform training on the face image generator using the second recognition score.

3. A control method performed by a computer, the method comprising:
acquiring a first profile face image and a first frontal face image, the first profile face image including a profile face of a subject, the first frontal face image including a frontal face of a same subject of the first profile face image;
generating a second frontal face image of the subject based on the acquired first profile face image using a face image generator, the face image generator is trained so as to generate the second frontal face image based on the first profile face image so that the frontal face image contains personal details of the subject;
performing face recognition on the second frontal face image with comparing to the first frontal face image, and thereby computing a first recognition score that indicates probability of that the second frontal face image and the first frontal face image are of the same subject; and
performing training on the face image generator using the first recognition score.

4. The control method of claim 3 further comprising:
acquiring a third frontal face image that includes a face of a subject, the subject of the third frontal face image being different from the subject of the first profile face image and the first frontal face image;
performing face recognition on the second frontal face image with comparing to the third frontal face image, and thereby computing a second recognition score that indicates probability of that the second frontal face image and third frontal face image are of the same subject; and
performing training on the face image generator using the second recognition score.

5. A non-transitory storage medium storing a program causing a computer to perform each step of the control method of claim 3.
